(19) United States
(12) Patent Application Publication
(10) Pub. No.: US 2026/0280793 A1
(43) Pub. Date: Sep. 17, 2026

(54) DEMODULATION REFERENCE SIGNAL PATTERNS FOR START AND LENGTH INDICATOR VALUES

(71) Applicant: QUALCOMM Incorporated, San Diego, CA (US)

(72) Inventors: Chih-Hao LIU, San Diego, CA (US); Somsubhra BARIK, San Diego, CA (US); Jing SUN, San Diego, CA (US)

(21) Appl. No.: 19/079,316

(22) Filed: Mar. 13, 2025

(51) Int. Cl. H04L 5/00; H04W 72/0446

(52) U.S. Cl. CPC H04L 5/0048; H04W 72/0446

(57) ABSTRACT

Various aspects of the present disclosure generally relate to wireless communication. In some aspects, a user equipment (UE) may receive an indication of a start and length indicator value (SLIV) that indicates a time domain resource allocation of more than one slot. The UE may communicate a plurality of demodulation reference signals (DMRSs) in accordance with one or more DMRS patterns associated with one or more time segments including one or more boundaries in the more than one slot. Numerous other aspects are described.

### FIELD OF THE DISCLOSURE

Aspects of the present disclosure generally relate to wireless communication and specifically relate to techniques, apparatuses, and methods associated with demodulation reference signal patterns for start and length indicator values.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A demodulation reference signal (DMRS) may carry information used to estimate a radio channel for demodulation of an associated physical channel. The design and mapping of a DMRS may be specific to a physical channel for which the DMRS is used for estimation. DMRSs are used for both downlink communications and uplink communications.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system that includes processor circuitry and code-storing memory circuitry. The processing system may be configured to cause the UE to receive an indication of a start and length indicator value (SLIV) that indicates a time domain resource allocation of more than one slot. The processing system may be configured to cause the UE to communicate a plurality of demodulation reference signals (DMRSs) in accordance with one or more DMRS patterns associated with one or more time segments including one or more boundaries in the more than one slot.

Some aspects described herein relate to a network node. The network node may include a processing system that includes processor circuitry and code-storing memory circuitry. The processing system may be configured to cause the network node to transmit an indication of a SLIV that indicates a time domain resource allocation of more than one slot. The processing system may be configured to cause the network node to communicate a plurality of DMRSs in accordance with one or more DMRS patterns associated with one or more time segments including one or more boundaries in the more than one slot.

Some aspects described herein relate to a method of wireless communication performed by a UE. The method may include receiving an indication of a SLIV that indicates a time domain resource allocation of more than one slot. The method may include communicating a plurality of DMRSs in accordance with one or more DMRS patterns associated with one or more time segments including one or more boundaries in the more than one slot.

Some aspects described herein relate to a method of wireless communication performed by a network node. The method may include transmitting an indication of a SLIV that indicates a time domain resource allocation of more than one slot. The method may include communicating a plurality of DMRSs in accordance with one or more DMRS patterns associated with one or more time segments including one or more boundaries in the more than one slot.

Some aspects described herein relate to an apparatus for wireless communication. The apparatus may include means for receiving an indication of a SLIV that indicates a time domain resource allocation of more than one slot. The apparatus may include means for communicating a plurality of DMRSs in accordance with one or more DMRS patterns associated with one or more time segments including one or more boundaries in the more than one slot.

Some aspects described herein relate to an apparatus for wireless communication. The apparatus may include means for transmitting an indication of a SLIV that indicates a time domain resource allocation of more than one slot. The apparatus may include means for communicating a plurality of DMRSs in accordance with one or more DMRS patterns associated with one or more time segments including one or more boundaries in the more than one slot.

Some aspects described herein relate to a non-transitory computer-readable medium that stores a set of instructions for wireless communication by a UE. The set of instructions, when executed by one or more processors of the UE, may cause the UE to receive an indication of a SLIV that indicates a time domain resource allocation of more than one slot. The set of instructions, when executed by one or more processors of the UE, may cause the UE to communicate a plurality of DMRSs in accordance with one or more DMRS patterns associated with one or more time segments including one or more boundaries in the more than one slot.

Some aspects described herein relate to a non-transitory computer-readable medium that stores a set of instructions for wireless communication by a network node. The set of instructions, when executed by one or more processors of the network node, may cause the network node to transmit an indication of a SLIV that indicates a time domain resource allocation of more than one slot. The set of instructions, when executed by one or more processors of the network node, may cause the network node to communicate a plurality of DMRSs in accordance with one or more DMRS patterns associated with one or more time segments including one or more boundaries in the more than one slot.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating examples of channel estimation.

FIG. 4 is a diagram illustrating an example of a uniform demodulation reference signal (DMRS) pattern.

FIG. 5 is a diagram illustrating an example of a long start and length indicator value (SLIV) for physical uplink shared channel (PUSCH).

FIG. 6 is a diagram illustrating an example associated with signaling for DMRS patterns for SLIVs.

FIG. 7 is a diagram illustrating an example associated with logical boundaries.

FIG. 8 is a diagram illustrating an example associated with physical boundaries.

FIG. 9 is a diagram illustrating an example process performed, for example, at a user equipment (UE) or an apparatus of a UE.

FIG. 10 is a diagram illustrating an example process performed, for example, at a network node or an apparatus of a network node.

FIG. 11 is a diagram of an example apparatus for wireless communication.

FIG. 12 is a diagram of an example apparatus for wireless communication.

### DETAILED DESCRIPTION

When scheduling a communication, a network node may transmit downlink control information (DCI) that indicates a time domain resource allocation (TDRA) for the communication. The TDRA may indicate a symbol-based scheduling unit (e.g., may schedule a TDRA in terms of a quantity of symbols). For example, the DCI may indicate a set of TDRA parameters for scheduling communications. For a downlink communication (e.g., a physical downlink shared channel (PDSCH) communication), the TDRA parameters may include, for example, a K0 value, an S value, and an L value. The K0 value may represent a scheduling offset (e.g., in number of slots) between the slot containing the scheduling DCI (that schedules the downlink communication) and the slot containing the scheduled downlink communication (scheduled by the scheduling DCI). The S value may represent a starting symbol for the downlink communication in the indicated slot. The L value may represent a length (e.g., a number of consecutive symbols) of the downlink communication (e.g., in the indicated slot). For an uplink communication (e.g., a PUSCH communication), the TDRA parameters may include, for example, a K2 value, an S value, and an L value. The K2 value may represent a scheduling offset (e.g., in number of slots) between the slot containing the scheduling DCI (that schedules the uplink communication) and the slot containing the scheduled uplink communication (scheduled by the scheduling DCI). The S value may represent a starting symbol for the uplink communication in the indicated slot. The L value may represent a length (e.g., a number of consecutive symbols) of the uplink communication (e.g., in the indicated slot). In some examples, an S value and an L value for a TDRA may be indicated or configured by a single value, referred to as a start and length indicator value (SLIV).

In some examples, a SLIV may indicate a TDRA that is confined to a single slot. For example, the UE may expect that the SLIV indicates a TDRA that is included within a single slot (e.g., that the TDRA does not cross a slot boundary between two different slots). In such examples, multiple TDRAs for respective transmissions of a physical channel (e.g., repeated transmissions, such as repeated PUSCH transmissions with multiple segments of back-to-back symbols) may be allocated in consecutive time domain resources such that the collective time domain resources of the multiple TDRAs may span across multiple slots, which may increase or extend the coverage of transmission for the physical channel. In such examples, the repeated transmissions may be different redundancy versions of a transmission. Each TDRA of the multiple TDRAs may not cross a slot boundary (e.g., although the collective time domain resources of the multiple TDRAs may cross a slot boundary).

In other examples, a SLIV may indicate a TDRA that is not limited or configured to a single slot or that can cross a slot boundary (e.g., to enable a TDRA for a physical channel to span multiple slots). A SLIV that indicates a TDRA that is not confined to a single slot or that crosses a slot boundary may be referred to as a “long” or “fluid” SLIV. For example, a long SLIV may allow a physical shared channel (PxSCH) allocation to cross a slot boundary. Long SLIVs may help to reduce the complexity that would otherwise be associated with scheduling or allocating multiple TDRAs for respective transmissions to extend the coverage for the physical channel, increase scheduling flexibility, or extend the coverage of transmission for a physical channel.

Spreading a transport block (TB) over multiple slots in a long SLIV (instead of carrying smaller TBs in each slot) may help to improve coding gain and reduce control overhead. However, applying a uniform demodulation reference signal (DMRS) pattern to certain slot type formats for a SLIV may extend a symbol spacing between DMRS symbols. For example, a uniform uplink DMRS pattern applied to a slot type format that includes only occasional uplink slots may increase a spacing between uplink DMRS symbols in the uniform uplink DMRS pattern (because the uplink DMRSs may have limited opportunities for transmission). Such extended symbol spacing may prevent effective time interpolation and, thus, hinder channel estimation.

Various aspects relate generally to decreasing spacing between DMRS symbols in long SLIVs. Some aspects more specifically relate to segment long SLIVs based on boundaries and determining a DMRS pattern per segment. In some aspects, the boundaries may be logical boundaries, such as boundaries that are based at least in part on nominal or actual time domain windows. In some aspects, the boundaries may be physical boundaries, such as boundaries that are based at least in part on physical gaps positioned between downlink slots and uplink slots. In some aspects, a physical gap may be greater than a preconfigured or predefined symbol threshold, and the DMRS pattern(s) may be determined for each contiguous time segment within the long SLIV. In some aspects, the physical gap may be less than the preconfigured or predefined symbol threshold, and the DMRS pattern(s) may be determined with respect to the entire long SLIV.

Particular aspects of the subject matter described in this disclosure can be implemented to realize one or more of the following potential advantages. In some examples, the described techniques can be used to improve channel estimation. For example, the boundaries may help to ensure that the one or more DMRS patterns are spaced appropriately for effective time interpolation. Determining the DMRS pattern(s) for each contiguous time segment within the long SLIV (e.g., in examples where the physical gap is greater than the preconfigured or predefined symbol threshold) may help to reduce DMRS overhead, such as in examples where the one or more respective time segments are longer than one slot. Determining the DMRS pattern(s) with respect to entire the long SLIV (e.g., in examples where the physical gap is less than the preconfigured or predefined symbol threshold) may help to reduce complexity associated with DMRS pattern determination.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

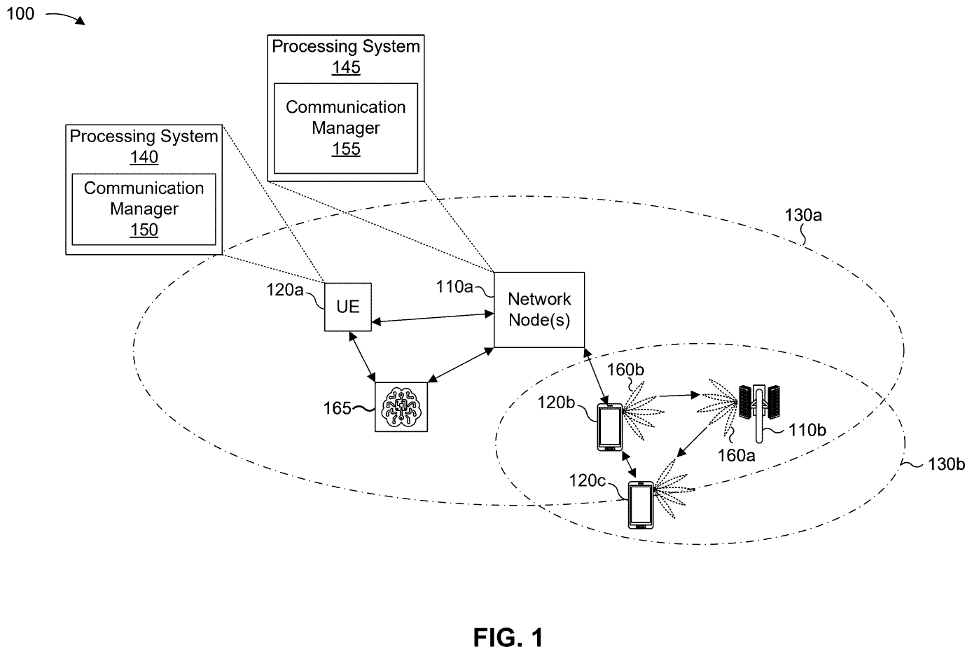

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a DMRS, a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more TBs of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive an indication of a SLIV that indicates a time domain resource allocation of more than one slot; and communicate a plurality of DMRSs in accordance with one or more DMRS patterns associated with one or more time segments including one or more boundaries in the more than one slot. Additionally, or alternatively, the communication manager 150 may perform one or more other operations described herein.

In some aspects, the network node 110 may include a communication manager 155. As described in more detail elsewhere herein, the communication manager 155 may transmit an indication of a SLIV that indicates a time domain resource allocation of more than one slot; and communicate a plurality of DMRSs in accordance with one or more DMRS patterns associated with one or more time segments including one or more boundaries in the more than one slot. Additionally, or alternatively, the communication manager 155 may perform one or more other operations described herein.

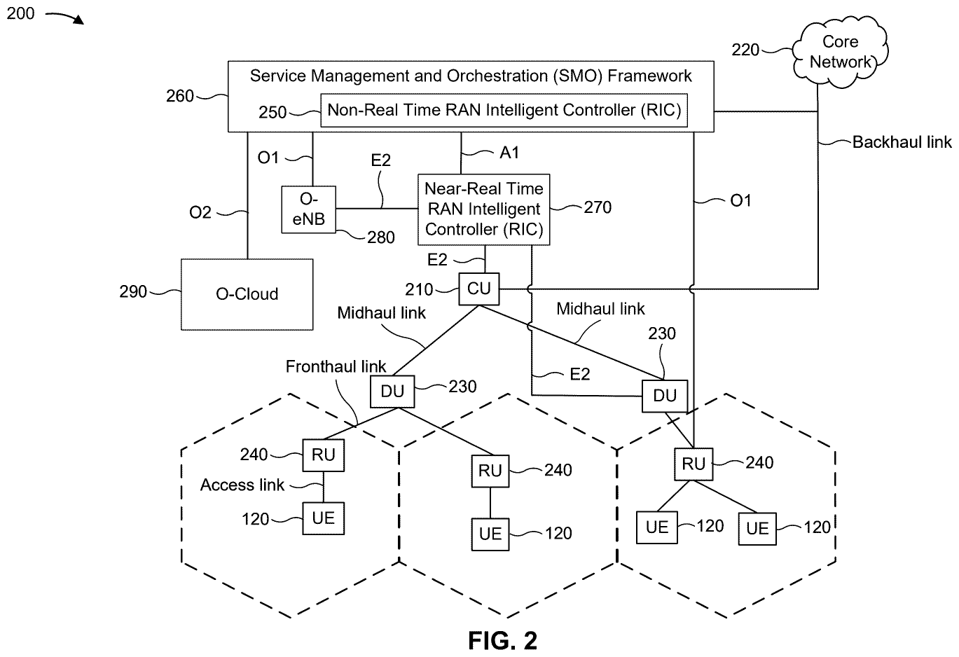

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

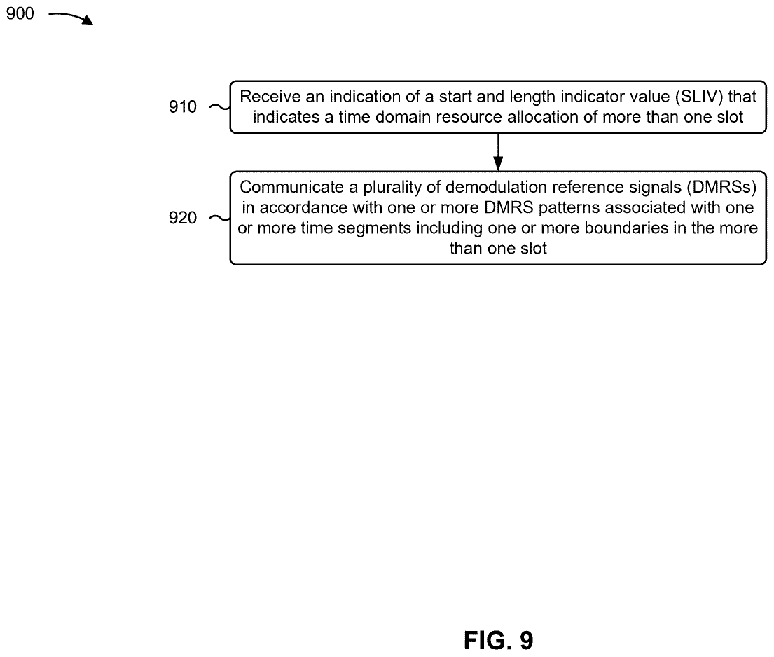

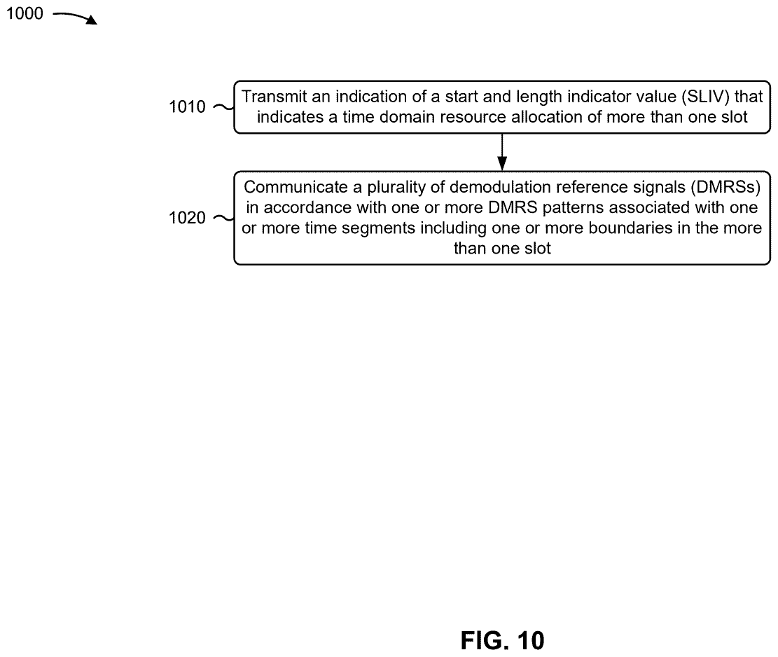

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with DMRS patterns for SLIVs, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, or interpreting the instructions, among other examples.

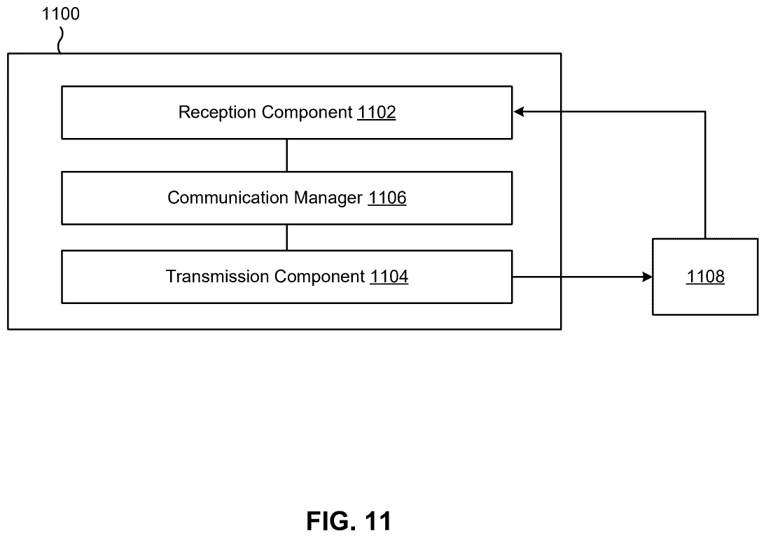

In some aspects, the UE 120 includes means for receiving an indication of a SLIV that indicates a time domain resource allocation of more than one slot; or means for communicating a plurality of DMRSs in accordance with one or more DMRS patterns associated with one or more time segments including one or more boundaries in the more than one slot. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

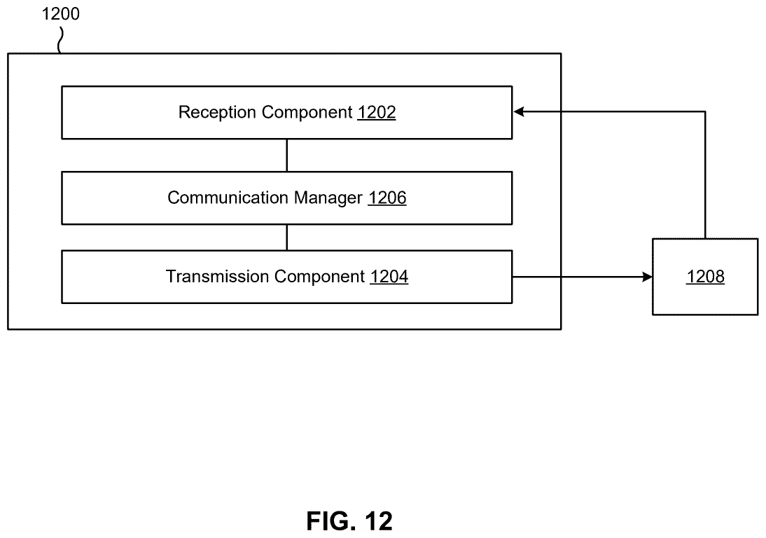

In some aspects, the network node 110 includes means for transmitting an indication of a SLIV that indicates a time domain resource allocation of more than one slot; or means for communicating a plurality of DMRSs in accordance with one or more DMRS patterns associated with one or more time segments including one or more boundaries in the more than one slot. The means for the network node 110 to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

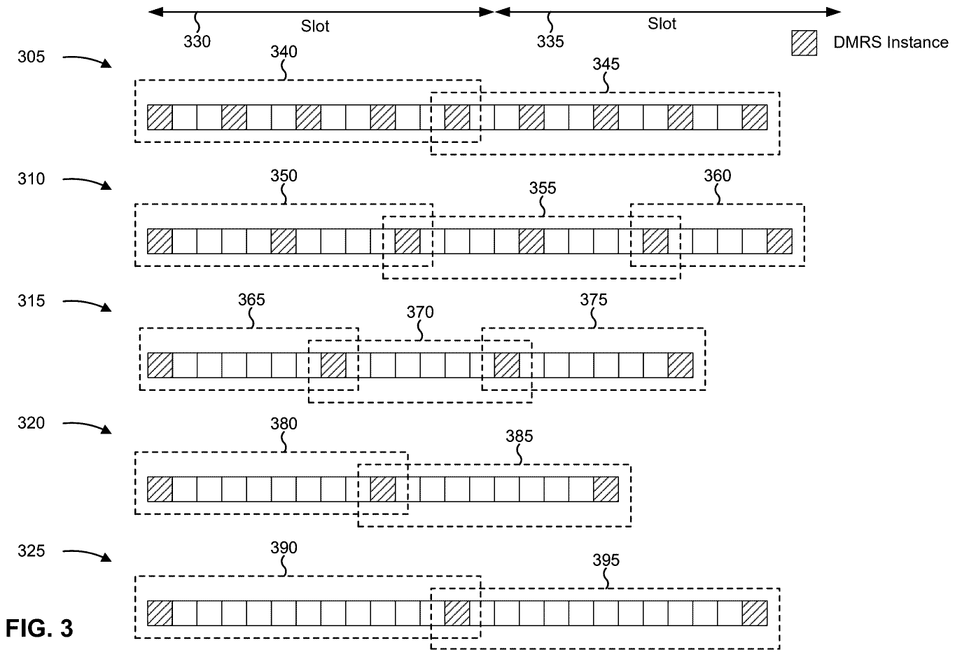

FIG. 3 is a diagram illustrating examples 305, 310, 315, and 320, and 325 of channel estimation.

In some examples, a transmitter (e.g., a UE 120 or a network node 110) and a receiver (e.g., a network node 110 or a UE 120) may communicate with each other. In some examples, the transmitter may transmit, and the receiver may receive, one or more DMRSs. The receiver may perform a channel estimation using the one or more DMRSs. For example, DMRS-based channel estimation may include the receiver detecting one or more DMRSs from a received signal, which may be affected by various channel impairments, such as path loss, multipath fading, or noise, among other examples. The receiver may extract the DMRS(s) from the received signal based on the known DMRS pattern (or locations) within the received signal. To perform channel estimation, the receiver may compare the received DMRS(s) with an expected DMRS, using a comparison approach, such as least square (LS) or minimum mean square error (MMSE) estimation. The comparison may be indicative of an estimate of the channel's effect on the received DMRS(s). This estimated channel response, which represents how the signal has been distorted during transmission, may be used to correct the received data signals, improving decoding accuracy. In some examples, the receiver may perform interpolation or extrapolation to refine the channel estimates and handle variations in the channel conditions over time and frequency.

As shown in FIG. 3, the transmitter and receiver may communicate during multiple slots, shown as a slot 330 and a slot 335. A slot may include one or more DMRS instances. In some examples, a DMRS instance may include a single symbol (e.g., a single OFDM symbol). In other examples, a DMRS instance may include multiple symbols (e.g., multiple OFDM symbols), such as two symbols. The receiver may perform a channel estimation using DMRSs received during a given channel estimation window, which may help to reduce a time domain density of DMRSs. The receiver may receive and store information associated with the DMRSs in a channel estimation window and may interpolate the channel estimate using the information associated with the DMRSs received during the channel estimation window. In some examples, this approach may be referred to as DMRS bundling.

DMRS bundling may involve a receiver (e.g., a UE) performing joint channel estimation using information obtained from DMRSs received in multiple DMRS instances. For example, the joint channel estimation may be performed using information obtained from DMRSs received in a given channel estimation window. A channel estimation window may include any suitable quantity of DMRS instances and may span any suitable quantity of symbols or slots. In example 305, DMRS instances are separated by two symbols, and the receiver may perform joint channel estimation in a channel estimation window 340 and a channel estimation window 345. In example 310, DMRS instances are separated by four symbols, and the receiver may perform joint channel estimation in a channel estimation window 350, a channel estimation window 355, and a channel estimation window 360. In example 315, DMRS instances are separated by six symbols, and the receiver may perform joint channel estimation in a channel estimation window 365, a channel estimation window 370, and a channel estimation window 375. In example 320, DMRS instances are separated by eight symbols, and the receiver may perform joint channel estimation in a channel estimation window 380 and a channel estimation window 385. In example 325, DMRS instances are separated by eleven symbols, and the receiver may perform joint channel estimation in a channel estimation window 390 and a channel estimation window 395. In examples 305, 310, 315, and 320, and 325, each of the DMRS instances follow a uniform time domain DMRS, which may help to reduce DMRS overhead in view of Doppler effects while exploiting benefits of DMRS and cell-specific reference signals (CRSs).

As indicated above, FIG. 3 is provided as an example. Other examples may differ from what is described with respect to FIG. 3.

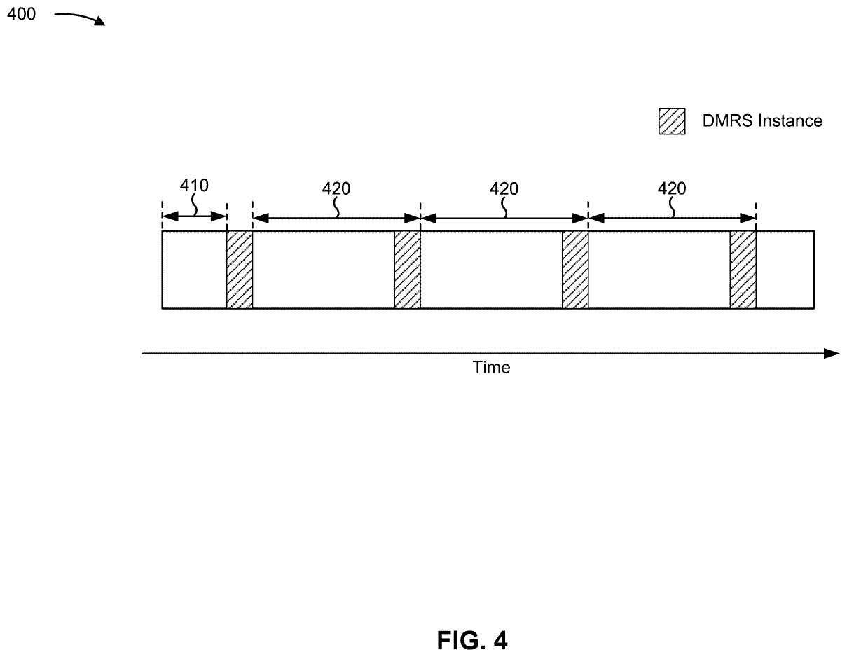

FIG. 4 is a diagram illustrating an example 400 of a uniform DMRS pattern.

The uniform DMRS pattern includes time domain locations of DMRS instances (e.g., DMRS symbols) that are evenly spaced across an entirety of a long SLIV. The time domain locations may be based at least in part on starting DMRS offset 410 and a DMRS separation 420. The starting DMRS offset 410 may indicate a time domain location of an initial DMRS instance in the uniform DMRS pattern. For example, the starting DMRS offset 410 may indicate a symbol offset of an initial DMRS symbol with respect to the long SLIV. The DMRS separation 420 may indicate a length of uniform time gaps between the DMRS instances within the uniform DMRS pattern.

As indicated above, FIG. 4 is provided as an example. Other examples may differ from what is described with respect to FIG. 4.

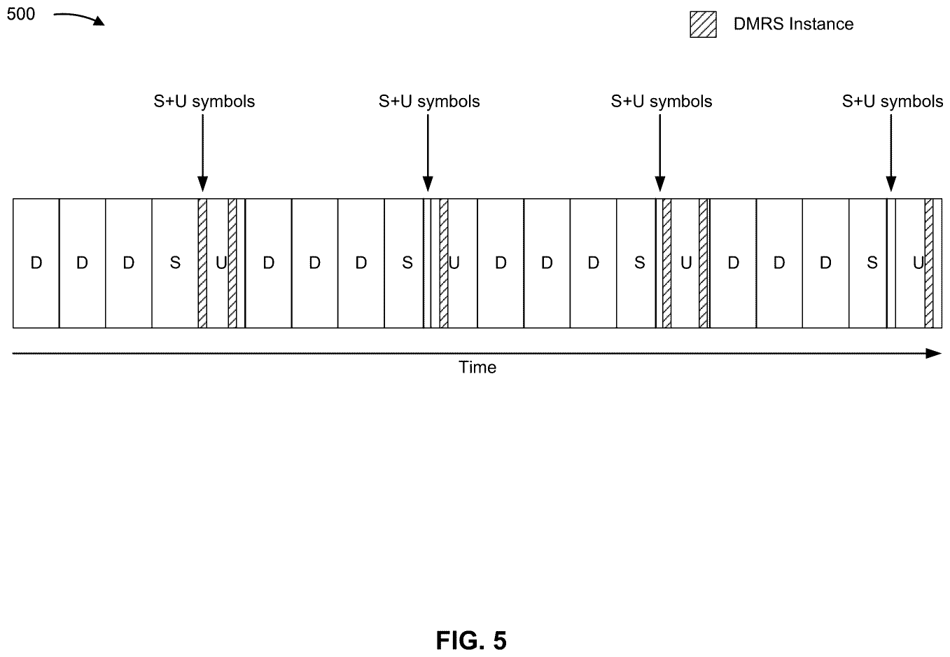

FIG. 5 is a diagram illustrating an example 500 of a long SLIV for PUSCH.

Example 500 shows a type slot format that includes a repeating set of three downlink slots (“D”), one special slot (“S”), and one uplink slot (“U”) for a time division duplex (TDD) carrier. The special slot may include one or more uplink symbols, downlink symbols, or a guard period between downlink and uplink transmissions. For example, the special slot may include one or more uplink symbols adjacent to an uplink slot. These uplink symbols are shows as “S+U symbols.” The “DDDSU” type slot format may lead to transmissions that are spread over multiple slots. Spreading a TB over multiple slots instead of carrying smaller TBs in each slot may help to improve coding gain and reduce control overhead. Thus, a TB may be spread across multiple uplink slots within the long SLIV. However, applying a uniform DMRS pattern to the DDDSU type slot format may extend a symbol spacing between DMRS symbols in uplink slots such that channel estimation is hindered. For example, if a DMRS separation of 12 uplink symbols is configured given certain Doppler assumption, then the symbol spacing between the second and third DMRS symbols may be 66 symbols, which may be too large to perform effective time interpolation.

As indicated above, FIG. 5 is provided as an example. Other examples may differ from what is described with respect to FIG. 5.

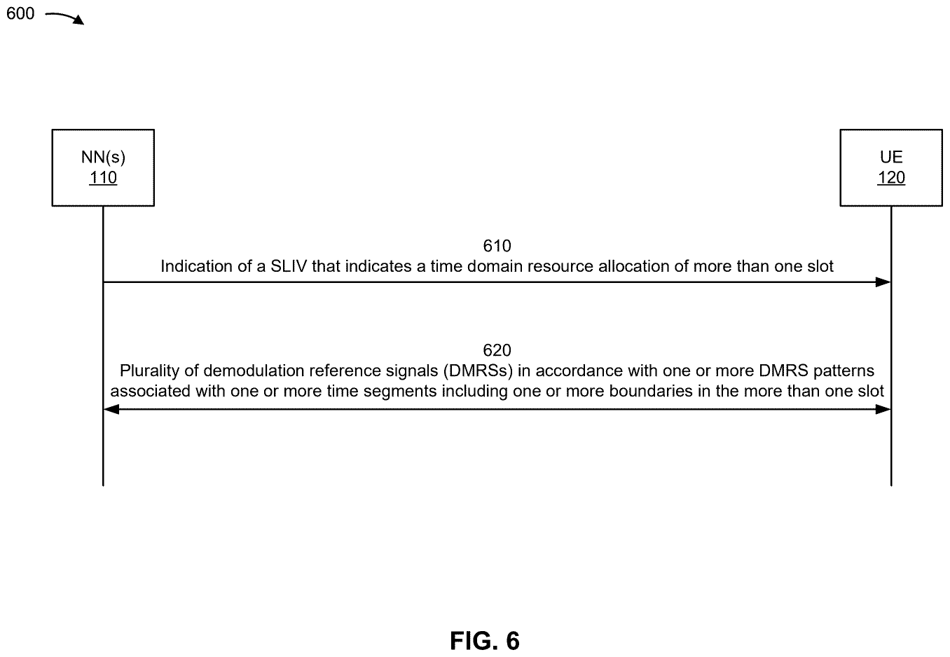

FIG. 6 is a diagram illustrating an example 600 associated with signaling for DMRS patterns for SLIVs. As shown in FIG. 6, a network node 110 and a UE 120 may communicate with one another.

As shown by reference number 610, the network node 110 may transmit (e.g., using the communication manager 155 or the transmission component 1204), and the UE 120 may receive (e.g., using the communication manager 150 or the reception component 1202), an indication of a SLIV that indicates a TDRA of more than one slot. For example, the SLIV may be a long or fluid SLIV. The TDRA may be of more than one slot in that the TDRA may be of at least one slot and one additional unit of time (e.g., at least one symbol). For example, the more than one slot may include multiple slots, or one slot and a portion of one or more additional slots. The indication of the SLIV may comprise configuration information (e.g., an RRC parameter), a MAC-CE, DCI, or the like.

As shown by reference number 610, the network node 110 and the UE 120 may communicate (e.g., using the communication manager 150, the communication manager 155, the reception component 1102, the transmission component 1104, the reception component 1202, or the transmission component 1204) a plurality of DMRSs in accordance with one or more DMRS patterns associated with one or more time segments including one or more boundaries in the more than one slot. In some examples, the network node 110 may transmit, and the UE 120 may receive, the plurality of DMRSs (e.g., in examples where the DMRSs are downlink DMRSs). In some examples, the UE 120 may transmit, and the network node 110 may receive, the plurality of DMRSs (e.g., in examples where the DMRSs are uplink DMRSs). The DMRSs may include one or more uplink DMRSs or one or more downlink DMRSs. In some examples, the one or more DMRS patterns may include DMRS instances (e.g., DMRS symbols) that carry the DMRSs, as discussed above in connection with FIGS. 3 and 4. The one or more DMRS patterns may be associated with the one or more time segments in that the one or more time segments may overlap in the time domain with the one or more DMRS patterns. The one or more boundaries may occur at any suitable time domain location in the one or more time segments, such as inside a time segment or at an edge of a time segment. The time domain locations of the one or more boundaries may depend on a UE channel estimation capability (e.g., a time domain duration of channel estimation), and may or may not align with slot boundaries. In some examples, the one or more boundaries may segment the SLIV based at least in part on the one or more boundaries, and the DMRS pattern may be determined per segment.

As indicated above, FIG. 6 is provided as an example. Other examples may differ from what is described with respect to FIG. 6.

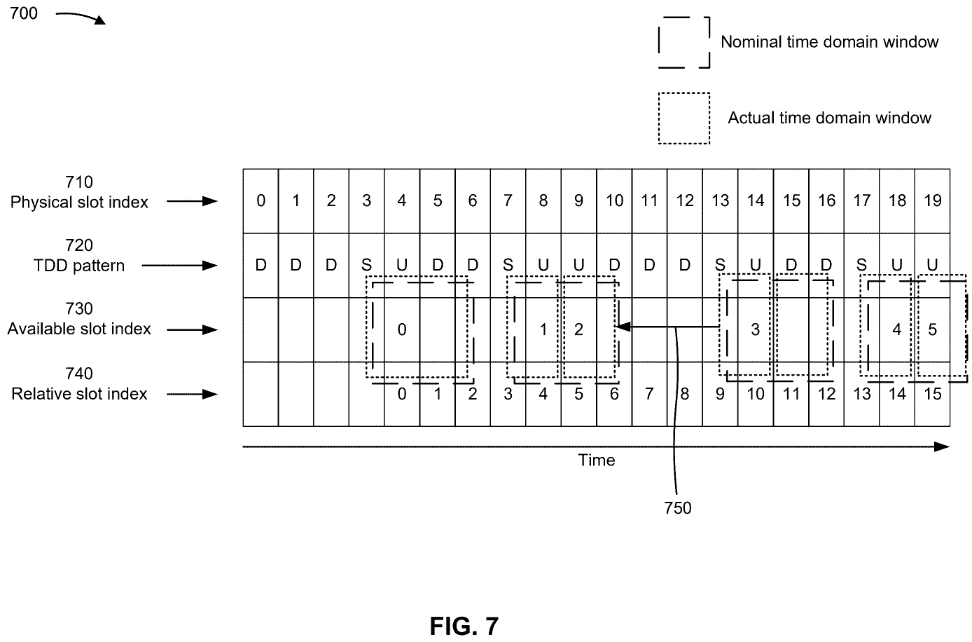

FIG. 7 is a diagram illustrating an example 700 associated with logical boundaries.

In some aspects, the one or more boundaries may include one or more time domain windows. For example, the boundaries may be identified based at least in part on the one or more time domain windows. The one or more time domain windows may be one or more DMRS combining time domain windows (e.g., any DMRSs received during the one or more time domain windows may be combined).

Example 700 shows a set of slots with respective physical slot indexes 710. The slots follow a TDD pattern 720, namely, “DDDSUDDSUU.” An available slot index 730 increments with each slot that includes a DMRS instance, and a relative slot index 740 increments with each slot beginning with an initial DMRS instance. Example 700 shows nominal time domain windows and actual time domain windows. If no dynamic events are detected, then DMRS combining may be performed within the nominal time domain windows. If a dynamic event is detected, then the nominal time domain windows may be split into actual time domain windows, and DMRS combining may be performed based at least in part on the actual time domain windows, as shown by arrow 750. The one or more boundaries may include one or more nominal time domain windows or one or more actual time domain windows. In some examples where the one or more boundaries include one or more time domain windows, the one or more boundaries may be referred to as “logical boundaries.” In some examples, the one or more DMRS patterns may be determined based at least in part on the logical boundaries.

As indicated above, FIG. 7 is provided as an example. Other examples may differ from what is described with respect to FIG. 7.

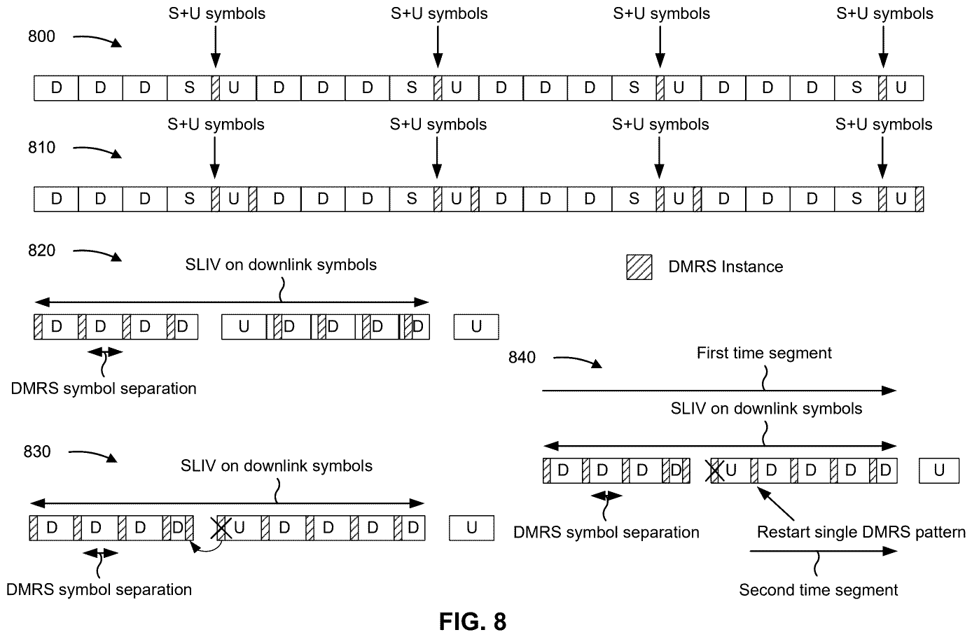

FIG. 8 is a diagram illustrating an example 800 associated with physical boundaries.

In some aspects, the one or more boundaries may include one or more symbol gaps. A symbol gap may be a time window in which the UE 120 does not transmit or receive communications (e.g., uplink or downlink communications). For example, a symbol gap may include one or more symbols that separate a downlink slot and an uplink slot. For example, a symbol gap may be positioned during a transition from a downlink slot to an uplink slot, as discussed above in connection with FIG. 5. In some examples where the one or more boundaries include one or more symbol gaps, the one or more boundaries may be referred to as “physical boundaries.” In some examples, the one or more DMRS patterns may be identified based at least in part on the physical boundaries. For example, the SLIV may be segmented into multiple time segments based at least in part on a TDD frame structure (e.g., a TDD pattern).

In some aspects, each of the one or more symbol gaps may satisfy a symbol gap threshold. For example, each symbol gap (e.g., physical gap) may exceed the symbol gap threshold (e.g., a preconfigured or predefined symbol threshold). For example, a physical gap may be larger than the preconfigured or predefined symbol threshold. In some aspects, the one or more DMRS patterns may be associated with one or more respective time segments of the one or more time segments. The one or more DMRS patterns may be associated with the one or more respective time segments in that the one or more DMRS patterns may be identified for the one or more respective time segments. For example, each time segment may include contiguous uplink or downlink symbols, and the one or more DMRS patterns may be identified per time segment (e.g., per contiguous allocation). For example, the one or more DMRS patterns may be determined per time segment (e.g., contiguous time segment) within the SLIV (e.g., the long SLIV). In a TDD system, a maximum length of a contiguous time segment may be known once an uplink and downlink pattern (e.g., DDSU) is configured by the network node 110.

In some aspects, the one or more DMRS patterns may be based at least in part on one or more offsets of one or more initial DMRS symbols in the one or more respective time segments from one or more starting symbols of the one or more respective time segments, one or more DMRS symbol separations, and one or more symbol distance thresholds. The one or more offsets of one or more initial DMRS symbols may be one or more first DMRS offsets A with respect to a starting symbol of each of the one or more respective time segments. The one or more DMRS symbol separations may be one or more back-to-back DMRS symbol separations S. The one or more symbol distance thresholds may be a largest symbol distance B to an end of each of the one or more respective time segments. In some examples, similar to providing a contiguous long SLIV DMRS pattern in each of the one or more respective time segments, the network node 110 may configure A, S, and B. In some examples, a same or similar procedure may be applied to each time segment. In some examples, different time segments may have different quantities of symbols. For example, an initial (e.g., first) time segment or a last time segment may have different quantities of symbols than one or more other time segments.

In some aspects, the one or more DMRS patterns may include one or more last DMRS symbols positioned based at least in part on the one or more DMRS symbol separations. For example, each of the one or more respective time segments may have a last DMRS symbol. In some aspects, the one or more DMRS patterns may further include one or more additional DMRS symbols in accordance with one or more symbol distances associated with the one or more last DMRS symbols satisfying the one or more symbol distance thresholds. A symbol distance may be a symbol distance from a last symbol of one of the respective time segments, and the one or more symbol distances may be associated with the one or more last DMRS symbols in that the one or more last DMRS symbols may be the one or more symbol distances from one or more last symbols of the one or more respective time segments. For example, if the one or more last DMRS symbols in the one or more respective time segments are B or more symbols away from one or more last symbols of the one or more respective time segments, then the one or more additional DMRS symbols may be added to one or more X^{th}-to-last symbols. In some examples, X may be a configurable value of zero or more (e.g., if X equals zero, then the one or more additional DMRS symbols may be added to the last symbol(s) of the one or more respective time segments). For instance, example 800 shows a DDDSU type slot format that includes one DMRS in each set of S+U symbols, and example 810 shows a DDDSU type slot format that includes one DMRS in each set of S+U symbols and an additional DMRS. If a last uniform DMRS symbol in the last time segment only (example 800) or every time segment (example 810) is B symbols away from the last symbol of a time segment, then an additional DMRS symbol may be added to the X^{th}-to-last symbol. In example 800, low Doppler or cross-slot combining may be assumed such that the receiver (e.g., the network node 110) may interpolate channels from DMRSs across multiple (e.g., two) time segments.

In some aspects, the one or more DMRS patterns may be based at least in part on one or more lengths of the one or more respective time segments, one or more starting symbol locations of the one or more respective time segments, and one or more maximum quantities of additional DMRSs. For example, the one or more DMRS patterns may be defined depending on different combinations of time segment length (e.g., the one or more lengths), and the DMRS patter per each time segment may be determined accordingly based at least in part on the one or more lengths, the one or more starting symbol locations, and a dmrs-AdditionalPosition parameter that indicates the one or more maximum quantities of additional DMRSs. For example, the network node 110 may configure DMRS patterns with different DMRS densities for time segments of equal lengths, and the network node 110 may choose the DMRS densities using the dmrs-AdditionalPosition parameter. In some examples, the network node 110 may configure a starting DMRS symbol offset with respect to a starting symbol of a time segment. In some examples, the DMRS pattern(s) may depend on the time segment length, a starting DMRS symbol and the dmrs-AdditionalPosition parameter. The starting DMRS symbol and the dmrs-AdditionalPosition parameter may be common to the one or more respective time segments, and the time segment length may vary from time segment to time segment.

In some aspects, each of the one or more symbol gaps may not satisfy a symbol gap threshold (e.g., a threshold quantity of symbols). For example, a physical gap may be less than the preconfigured or predefined symbol threshold. In some aspects, the one or more DMRS patterns may be a single DMRS pattern associated with the more than one slot. The single DMRS pattern may be associated with the more than one slot in that the single DMRS pattern may be determined with respect to the entire SLIV (e.g., the entire long SLIV). For example, the single DMRS pattern may be a fluid SLIV DMRS pattern with a symbol or slot gap.

In some aspects, the single DMRS pattern may include one or more DMRS symbols that are positioned based at least in part on a DMRS symbol separation in respective symbols of the more than one slot. The DMRS symbol separation may be a quantity of symbols by which the one or more DMRS symbols are separated. In some aspects, the DMRS symbol separation may be associated with a symbol type of the respective symbols. The DMRS symbol separation may be associated with the symbol type in that the DMRS symbols are separated by the DMRS symbol separation as measured in the symbol type (e.g., the symbol type may be downlink, or the symbol type may be uplink). For example, if the symbol gap in the SLIV is less than the symbol gap threshold, then the SLIV may evenly distribute the DMRS symbols across the downlink symbols only or the uplink symbols only. The SLIV may evenly distribute the DMRS symbols with special (“S”) symbol spacing in downlink symbols only or uplink symbols only (e.g., for downlink, only the downlink symbols may be taken into account in counting the S symbol spacing, and for uplink, only the uplink symbols may be taken into account in counting the S symbol spacing). For instance, example 820 shows a SLIV on a plurality of downlink symbols that allocates DMRSs separated by the DMRS symbol separation according to downlink symbols only. In some examples, the network node 110 may configure initial (e.g., first) DMRS symbol offset A symbols and a maximum last DMRS symbol offset with respect to an ending symbol of the SLIV.

In some aspects, the single DMRS pattern may include one or more DMRS symbols that are positioned based at least in part on a DMRS symbol separation in respective symbols of the more than one slot. The DMRS symbol separation may be a quantity of symbols by which the one or more DMRS symbols are separated. In some aspects, the one or more DMRS symbols may include at least one DMRS symbol that is punctured or repositioned in accordance with the at least one DMRS symbol colliding with a symbol having a symbol type that is different than a symbol type of the respective symbols. For example, if the symbol gap in the SLIV is less than the symbol gap threshold, then the SLIV may evenly distribute the DMRS symbols across the downlink and uplink symbols. If a DMRS symbol collides with one or more gap or uplink symbols for a downlink fluid SLIV, then a corresponding DMRS may be punctured or repositioned (e.g., moved) to the closest downlink symbol(s). For example, if the DMRS collides with (e.g., hits) a gap symbol or a symbol of the other direction (e.g., downlink or uplink), then the DMRS may be punctured or moved around. For the downlink fluid SLIV, the DMRS symbols may be evenly distributed based at least in part on the (A, S, B) parameters across the slot symbols, including the downlink, uplink, or gap symbols, and if a DMRS collides with uplink or gap symbols, then the DMRS symbol may be moved to the closest downlink symbol(s) or punctured, or the network node 110 may adjust the (A, S, B) parameters to minimize issues relating to the collision. For instance, example 830 shows a SLIV on a plurality of downlink symbols, where a DMRS symbol collides with an uplink symbol and, therefore, is repositioned to a closest downlink symbol. Additionally, or alternatively, if a DMRS symbol collides with one or more gap or downlink symbols for an uplink fluid SLIV, then a corresponding DMRS may be punctured or repositioned (e.g., moved) to the closest uplink symbol(s). For the uplink fluid SLIV, the DMRS symbols may be evenly distributed based at least in part on the (A, S, B) parameters across the slot symbols, including the downlink, uplink, or gap symbols, and if a DMRS collides with downlink or gap symbols, then the DMRS symbol may be moved to the closest uplink symbol(s) or punctured, or the network node 110 may adjust the (A, S, B) parameters to minimize issues relating to the collision.

In some aspects, the single DMRS pattern may be based at least in part on an offset of an initial DMRS symbol of the one or more DMRS symbols from a starting symbol of the more than one slot, a DMRS symbol separation, and a symbol distance threshold. For example, if the symbol gap in the SLIV is less than the symbol gap threshold, then the SLIV may evenly distribute the one or more DMRS symbols across the downlink and uplink symbols from the first uplink or downlink symbols of an initial (e.g., a first) time segment based on the (A, S, B) parameters. In some aspects, the single DMRS pattern may restart in accordance with at least one DMRS symbol of the single DMRS pattern colliding with a symbol having a symbol type that is different than a symbol type of the respective symbols. For example, the SLIV may start with the DMRS pattern (A, S, B) allocation for the entire SLIV (e.g., including the gap symbols and symbols of the other direction), and if a DMRS symbol collision occurs (e.g., a collision with one or more gap symbols or symbols of the other direction), then the single DMRS pattern may be restarted with the DMRS pattern (A, S, B) allocation on the uplink or downlink symbol time segments after the gap symbol(s) or symbol(s) of the other direction. For instance, example 840 shows a SLIV on a plurality of downlink symbols. The DMRS pattern (A, S, B) allocation is applied to the first time segment (which may span the entire SLIV). As shown, a DMRS may collide with one or more gap symbols or uplink symbols, and the single DMRS pattern may be restarted (with the DMRS pattern (A, S, B) allocation) from a second time segment starting from a symbol after the one or more gap symbols or uplink symbols. As a result, collision may be avoided in examples where S is not adjusted to avoid collisions (e.g., because S is chosen based at least in part on a Doppler effect).

Communicating a plurality of DMRSs in accordance with one or more DMRS patterns associated with one or more time segments including one or more boundaries in the more than one slot may help to improve channel estimation. For example, the one or more boundaries may help to ensure that the one or more DMRS patterns are spaced appropriately for effective time interpolation.

Each of the one or more symbol gaps satisfying a symbol gap threshold, and the one or more DMRS patterns being associated with the one or more respective time segments of the one or more time segments, may help to reduce DMRS overhead, such as in examples where the one or more respective time segments are longer than one slot.

Each of the one or more symbol gaps not satisfying a symbol gap threshold, and the one or more DMRS patterns being a single DMRS pattern associated with the more than one slot, may help to reduce complexity associated with DMRS pattern determination. For example, if a gap in the SLIV is a small quantity of symbols, then the DMRS pattern may be determined for the entire SLIV.

FIG. 9 is a diagram illustrating an example process 900 performed, for example, at a UE or an apparatus of a UE. Example process 900 is an example where the apparatus or the UE (e.g., UE 120) performs operations associated with DMRS patterns for SLIVs.

As shown in FIG. 9, in some aspects, process 900 may include receiving an indication of a SLIV that indicates a time domain resource allocation of more than one slot (block 910). For example, the UE (e.g., using reception component 1102 or communication manager 1106, depicted in FIG. 11) may receive an indication of a SLIV that indicates a time domain resource allocation of more than one slot, as described above in connection with reference number 610.

As further shown in FIG. 9, in some aspects, process 900 may include communicating a plurality of DMRSs in accordance with one or more DMRS patterns associated with one or more time segments including one or more boundaries in the more than one slot (block 920). For example, the UE (e.g., using reception component 1102, transmission component 1104, or communication manager 1106, depicted in FIG. 11) may communicate a plurality of DMRSs in accordance with one or more DMRS patterns associated with one or more time segments including one or more boundaries in the more than one slot, as described above in connection with reference number 620.

Process 900 may include additional aspects, such as any single aspect or any combination of aspects described below or in connection with one or more other processes described elsewhere herein.

In a first aspect, the one or more boundaries comprise one or more time domain windows. In a second aspect, alone or in combination with the first aspect, the one or more boundaries comprise one or more symbol gaps.

In a third aspect, alone or in combination with one or more of the first and second aspects, each of the one or more symbol gaps satisfy a symbol gap threshold, and the one or more DMRS patterns are associated with one or more respective time segments of the one or more time segments.

In a fourth aspect, alone or in combination with one or more of the first through third aspects, the one or more DMRS patterns are based at least in part on one or more offsets of one or more initial DMRS symbols in the one or more respective time segments from one or more starting symbols of the one or more respective time segments, one or more DMRS symbol separations, and one or more symbol distance thresholds.

In a fifth aspect, alone or in combination with one or more of the first through fourth aspects, the one or more DMRS patterns include one or more last DMRS symbols positioned based at least in part on the one or more DMRS symbol separations, and the one or more DMRS patterns further include one or more additional DMRS symbols in accordance with one or more symbol distances associated with the one or more last DMRS symbols satisfying the one or more symbol distance thresholds.

In a sixth aspect, alone or in combination with one or more of the first through fifth aspects, the one or more DMRS patterns are based at least in part on one or more lengths of the one or more respective time segments, one or more starting symbol locations of the one or more respective time segments, and one or more maximum quantities of additional DMRSs.

In a seventh aspect, alone or in combination with one or more of the first through sixth aspects, each of the one or more symbol gaps do not satisfy a symbol gap threshold, and the one or more DMRS patterns is a single DMRS pattern associated with the more than one slot.

In an eighth aspect, alone or in combination with one or more of the first through seventh aspects, the single DMRS pattern includes one or more DMRS symbols that are positioned based at least in part on a DMRS symbol separation in respective symbols of the more than one slot, and the DMRS symbol separation is associated with a symbol type of the respective symbols.

In a ninth aspect, alone or in combination with one or more of the first through eighth aspects, the single DMRS pattern includes one or more DMRS symbols that are positioned based at least in part on a DMRS symbol separation in respective symbols of the more than one slot, and the one or more DMRS symbols include at least one DMRS symbol that is punctured or repositioned in accordance with the at least one DMRS symbol colliding with a symbol having a symbol type that is different than a symbol type of the respective symbols.

In a tenth aspect, alone or in combination with one or more of the first through ninth aspects, the single DMRS pattern is based at least in part on an offset of an initial DMRS symbol of the one or more DMRS symbols from a starting symbol of the more than one slot, a DMRS symbol separation, and a symbol distance threshold, and the single DMRS pattern restarts in accordance with at least one DMRS symbol of the single DMRS pattern colliding with a symbol having a symbol type that is different than a symbol type of the respective symbols.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node. Example process 1000 is an example where the apparatus or the network node (e.g., network node 110) performs operations associated with DMRS patterns for SLIVs.

As shown in FIG. 10, in some aspects, process 1000 may include transmitting an indication of a SLIV that indicates a time domain resource allocation of more than one slot (block 1010). For example, the network node (e.g., using transmission component 1204 or communication manager 1206, depicted in FIG. 12) may transmit an indication of a SLIV that indicates a time domain resource allocation of more than one slot, as described above in connection with reference number 610.

As further shown in FIG. 10, in some aspects, process 1000 may include communicating a plurality of DMRSs in accordance with one or more DMRS patterns associated with one or more time segments including one or more boundaries in the more than one slot (block 1020). For example, the network node (e.g., using reception component 1202, transmission component 1204, or communication manager 1206, depicted in FIG. 12) may communicate a plurality of DMRSs in accordance with one or more DMRS patterns associated with one or more time segments including one or more boundaries in the more than one slot, as described above in connection with reference number 620.

Process 1000 may include additional aspects, such as any single aspect or any combination of aspects described below or in connection with one or more other processes described elsewhere herein.

In a first aspect, the one or more boundaries comprise one or more time domain windows. In a second aspect, alone or in combination with the first aspect, the one or more boundaries comprise one or more symbol gaps.

In a third aspect, alone or in combination with one or more of the first and second aspects, each of the one or more symbol gaps satisfy a symbol gap threshold, and the one or more DMRS patterns are associated with one or more respective time segments of the one or more time segments.

In a fourth aspect, alone or in combination with one or more of the first through third aspects, the one or more DMRS patterns are based at least in part on one or more offsets of one or more initial DMRS symbols in the one or more respective time segments from one or more starting symbols of the one or more respective time segments, one or more DMRS symbol separations, and one or more symbol distance thresholds.

In a fifth aspect, alone or in combination with one or more of the first through fourth aspects, the one or more DMRS patterns include one or more last DMRS symbols positioned based at least in part on the one or more DMRS symbol separations, and the one or more DMRS patterns further include one or more additional DMRS symbols in accordance with one or more symbol distances associated with the one or more last DMRS symbols satisfying the one or more symbol distance thresholds.

In a sixth aspect, alone or in combination with one or more of the first through fifth aspects, the one or more DMRS patterns are based at least in part on one or more lengths of the one or more respective time segments, one or more starting symbol locations of the one or more respective time segments, and one or more maximum quantities of additional DMRSs.

In a seventh aspect, alone or in combination with one or more of the first through sixth aspects, each of the one or more symbol gaps do not satisfy a symbol gap threshold, and the one or more DMRS patterns is a single DMRS pattern associated with the more than one slot.

In an eighth aspect, alone or in combination with one or more of the first through seventh aspects, the single DMRS pattern includes one or more DMRS symbols that are positioned based at least in part on a DMRS symbol separation in respective symbols of the more than one slot, and the DMRS symbol separation is associated with a symbol type of the respective symbols.

In a ninth aspect, alone or in combination with one or more of the first through eighth aspects, the single DMRS pattern includes one or more DMRS symbols that are positioned based at least in part on a DMRS symbol separation in respective symbols of the more than one slot, and the one or more DMRS symbols include at least one DMRS symbol that is punctured or repositioned in accordance with the at least one DMRS symbol colliding with a symbol having a symbol type that is different than a symbol type of the respective symbols.

In a tenth aspect, alone or in combination with one or more of the first through ninth aspects, the single DMRS pattern is based at least in part on an offset of an initial DMRS symbol of the one or more DMRS symbols from a starting symbol of the more than one slot, a DMRS symbol separation, and a symbol distance threshold, and the single DMRS pattern restarts in accordance with at least one DMRS symbol of the single DMRS pattern colliding with a symbol having a symbol type that is different than a symbol type of the respective symbols.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 6-8. Additionally, or alternatively, the apparatus 1100 may be configured to perform one or more processes described herein, such as process 900 of FIG. 9. In some aspects, the apparatus 1100 or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The reception component 1102 may receive an indication of a SLIV that indicates a time domain resource allocation of more than one slot. The reception component 1102 or the transmission component 1104 may communicate a plurality of DMRSs in accordance with one or more DMRS patterns associated with one or more time segments including one or more boundaries in the more than one slot.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network node, or a network node may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 6-8. Additionally, or alternatively, the apparatus 1200 may be configured to perform one or more processes described herein, such as process 1000 of FIG. 10. In some aspects, the apparatus 1200 or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 or the transmission component 1204 may include or may be included in a network interface. The network interface may be configured to obtain or output signals for the apparatus 1200 via one or more communications links, such as a backhaul link, a midhaul link, or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The transmission component 1204 may transmit an indication of a SLIV that indicates a time domain resource allocation of more than one slot. The reception component 1202 or the transmission component 1204 may communicate a plurality of DMRSs in accordance with one or more DMRS patterns associated with one or more time segments including one or more boundaries in the more than one slot.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving an indication of a start and length indicator value (SLIV) that indicates a time domain resource allocation of more than one slot; and communicating a plurality of demodulation reference signals (DMRSs) in accordance with one or more DMRS patterns associated with one or more time segments including one or more boundaries in the more than one slot.

Aspect 2: The method of Aspect 1, wherein the one or more boundaries comprise one or more time domain windows.

Aspect 3: The method of any of Aspects 1-2, wherein the one or more boundaries comprise one or more symbol gaps.

Aspect 4: The method of Aspect 3, wherein each of the one or more symbol gaps satisfy a symbol gap threshold, and the one or more DMRS patterns are associated with one or more respective time segments of the one or more time segments.

Aspect 5: The method of Aspect 4, wherein the one or more DMRS patterns are based at least in part on one or more offsets of one or more initial DMRS symbols in the one or more respective time segments from one or more starting symbols of the one or more respective time segments, one or more DMRS symbol separations, and one or more symbol distance thresholds.

Aspect 6: The method of Aspect 5, wherein the one or more DMRS patterns include one or more last DMRS symbols positioned based at least in part on the one or more DMRS symbol separations, and the one or more DMRS patterns further include one or more additional DMRS symbols in accordance with one or more symbol distances associated with the one or more last DMRS symbols satisfying the one or more symbol distance thresholds.

Aspect 7: The method of Aspect 4, wherein the one or more DMRS patterns are based at least in part on one or more lengths of the one or more respective time segments, one or more starting symbol locations of the one or more respective time segments, and one or more maximum quantities of additional DMRSs.

Aspect 8: The method of Aspect 3, wherein each of the one or more symbol gaps do not satisfy a symbol gap threshold, and the one or more DMRS patterns is a single DMRS pattern associated with the more than one slot.

Aspect 9: The method of Aspect 8, wherein the single DMRS pattern includes one or more DMRS symbols that are positioned based at least in part on a DMRS symbol separation in respective symbols of the more than one slot, and the DMRS symbol separation is associated with a symbol type of the respective symbols.

Aspect 10: The method of Aspect 8, wherein the single DMRS pattern includes one or more DMRS symbols that are positioned based at least in part on a DMRS symbol separation in respective symbols of the more than one slot, and the one or more DMRS symbols include at least one DMRS symbol that is punctured or repositioned in accordance with the at least one DMRS symbol colliding with a symbol having a symbol type that is different than a symbol type of the respective symbols.

Aspect 11: The method of Aspect 8, wherein the single DMRS pattern is based at least in part on an offset of an initial DMRS symbol of the one or more DMRS symbols from a starting symbol of the more than one slot, a DMRS symbol separation, and a symbol distance threshold, and wherein the single DMRS pattern restarts in accordance with at least one DMRS symbol of the single DMRS pattern colliding with a symbol having a symbol type that is different than a symbol type of the respective symbols.

Aspect 12: A method of wireless communication performed by a network node, comprising: transmitting an indication of a start and length indicator value (SLIV) that indicates a time domain resource allocation of more than one slot; and communicating a plurality of demodulation reference signals (DMRSs) in accordance with one or more DMRS patterns associated with one or more time segments including one or more boundaries in the more than one slot.

Aspect 13: The method of Aspect 12, wherein the one or more boundaries comprise one or more time domain windows.

Aspect 14: The method of any of Aspects 12-13, wherein the one or more boundaries comprise one or more symbol gaps.

Aspect 15: The method of Aspect 14, wherein each of the one or more symbol gaps satisfy a symbol gap threshold, and the one or more DMRS patterns are associated with one or more respective time segments of the one or more time segments.

Aspect 16: The method of Aspect 15, wherein the one or more DMRS patterns are based at least in part on one or more offsets of one or more initial DMRS symbols in the one or more respective time segments from one or more starting symbols of the one or more respective time segments, one or more DMRS symbol separations, and one or more symbol distance thresholds.

Aspect 17: The method of Aspect 16, wherein the one or more DMRS patterns include one or more last DMRS symbols positioned based at least in part on the one or more DMRS symbol separations, and the one or more DMRS patterns further include one or more additional DMRS symbols in accordance with one or more symbol distances associated with the one or more last DMRS symbols satisfying the one or more symbol distance thresholds.

Aspect 18: The method of Aspect 15, wherein the one or more DMRS patterns are based at least in part on one or more lengths of the one or more respective time segments, one or more starting symbol locations of the one or more respective time segments, and one or more maximum quantities of additional DMRSs.

Aspect 19: The method of Aspect 14, wherein each of the one or more symbol gaps do not satisfy a symbol gap threshold, and the one or more DMRS patterns is a single DMRS pattern associated with the more than one slot.

Aspect 20: The method of Aspect 19, wherein the single DMRS pattern includes one or more DMRS symbols that are positioned based at least in part on a DMRS symbol separation in respective symbols of the more than one slot, and the DMRS symbol separation is associated with a symbol type of the respective symbols.

Aspect 21: The method of Aspect 19, wherein the single DMRS pattern includes one or more DMRS symbols that are positioned based at least in part on a DMRS symbol separation in respective symbols of the more than one slot, and the one or more DMRS symbols include at least one DMRS symbol that is punctured or repositioned in accordance with the at least one DMRS symbol colliding with a symbol having a symbol type that is different than a symbol type of the respective symbols.

Aspect 22: The method of Aspect 19, wherein the single DMRS pattern is based at least in part on an offset of an initial DMRS symbol of the one or more DMRS symbols from a starting symbol of the more than one slot, a DMRS symbol separation, and a symbol distance threshold, and wherein the single DMRS pattern restarts in accordance with at least one DMRS symbol of the single DMRS pattern colliding with a symbol having a symbol type that is different than a symbol type of the respective symbols.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 24: An apparatus for wireless communication at a device, the apparatus comprising one or more memories and one or more processors coupled to the one or more memories, the one or more processors configured to cause the device to perform the method of one or more of Aspects 1-22.

Aspect 25: An apparatus for wireless communication, the apparatus comprising at least one means for performing the method of one or more of Aspects 1-22.

Aspect 26: A non-transitory computer-readable medium storing code for wireless communication, the code comprising instructions executable by one or more processors to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

Aspect 28: A device for wireless communication, the device comprising a processing system that includes one or more processors and one or more memories coupled with the one or more processors, the processing system configured to cause the device to perform the method of one or more of Aspects 1-22.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

Aspect 30: A device comprising a processing system that includes one or more processors and one or more code-storing memories coupled with the one or more processors, the processing system configured to cause the device to perform the method of one or more of Aspects 1-22.

Aspect 31: A device comprising a processing system that includes processor circuitry and code-storing memory circuitry, the processing system configured to cause the device to perform the method of one or more of Aspects 1-22.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes processor circuitry and code-storing memory circuitry, the processing system configured to cause the UE to:
receive an indication of a start and length indicator value (SLIV) that indicates a time domain resource allocation of more than one slot; and
communicate a plurality of demodulation reference signals (DMRSs) in accordance with one or more DMRS patterns associated with one or more time segments including one or more boundaries in the more than one slot.

2. The UE of claim 1, wherein the one or more boundaries comprise one or more time domain windows.

3. The UE of claim 1, wherein the one or more boundaries comprise one or more symbol gaps.

4. The UE of claim 3, wherein each of the one or more symbol gaps satisfy a symbol gap threshold, and the one or more DMRS patterns are associated with one or more respective time segments of the one or more time segments.

5. The UE of claim 4, wherein the one or more DMRS patterns are based at least in part on one or more offsets of one or more initial DMRS symbols in the one or more respective time segments from one or more starting symbols of the one or more respective time segments, one or more DMRS symbol separations, and one or more symbol distance thresholds.

6. The UE of claim 5, wherein the one or more DMRS patterns include one or more last DMRS symbols positioned based at least in part on the one or more DMRS symbol separations, and the one or more DMRS patterns further include one or more additional DMRS symbols in accordance with one or more symbol distances associated with the one or more last DMRS symbols satisfying the one or more symbol distance thresholds.

7. The UE of claim 4, wherein the one or more DMRS patterns are based at least in part on one or more lengths of the one or more respective time segments, one or more starting symbol locations of the one or more respective time segments, and one or more maximum quantities of additional DMRSs.

8. The UE of claim 3, wherein each of the one or more symbol gaps do not satisfy a symbol gap threshold, and the one or more DMRS patterns is a single DMRS pattern associated with the more than one slot.

9. The UE of claim 8, wherein the single DMRS pattern includes one or more DMRS symbols that are positioned based at least in part on a DMRS symbol separation in respective symbols of the more than one slot, and the DMRS symbol separation is associated with a symbol type of the respective symbols.

10. The UE of claim 8, wherein the single DMRS pattern includes one or more DMRS symbols that are positioned based at least in part on a DMRS symbol separation in respective symbols of the more than one slot, and the one or more DMRS symbols include at least one DMRS symbol that is punctured or repositioned in accordance with the at least one DMRS symbol colliding with a symbol having a symbol type that is different than a symbol type of the respective symbols.

11. The UE of claim 8, wherein the single DMRS pattern is based at least in part on an offset of an initial DMRS symbol of the one or more DMRS symbols from a starting symbol of the more than one slot, a DMRS symbol separation, and a symbol distance threshold, and wherein the single DMRS pattern restarts in accordance with at least one DMRS symbol of the single DMRS pattern colliding with a symbol having a symbol type that is different than a symbol type of the respective symbols.

12. A method of wireless communication performed by a user equipment (UE), comprising:
receiving an indication of a start and length indicator value (SLIV) that indicates a time domain resource allocation of more than one slot; and
communicating a plurality of demodulation reference signals (DMRSs) in accordance with one or more DMRS patterns associated with one or more time segments including one or more boundaries in the more than one slot.

13. The method of claim 12, wherein the one or more boundaries comprise one or more time domain windows.

14. The method of claim 12, wherein the one or more boundaries comprise one or more symbol gaps.

15. The method of claim 14, wherein each of the one or more symbol gaps satisfy a symbol gap threshold, and the one or more DMRS patterns are associated with one or more respective time segments of the one or more time segments.

16. The method of claim 15, wherein the one or more DMRS patterns are based at least in part on one or more offsets of one or more initial DMRS symbols in the one or more respective time segments from one or more starting symbols of the one or more respective time segments, one or more DMRS symbol separations, and one or more symbol distance thresholds.

17. The method of claim 16, wherein the one or more DMRS patterns include one or more last DMRS symbols positioned based at least in part on the one or more DMRS symbol separations, and the one or more DMRS patterns further include one or more additional DMRS symbols in accordance with one or more symbol distances associated with the one or more last DMRS symbols satisfying the one or more symbol distance thresholds.

18. The method of claim 15, wherein the one or more DMRS patterns are based at least in part on one or more lengths of the one or more respective time segments, one or more starting symbol locations of the one or more respective time segments, and one or more maximum quantities of additional DMRSs.

19. The method of claim 14, wherein each of the one or more symbol gaps do not satisfy a symbol gap threshold, and the one or more DMRS patterns is a single DMRS pattern associated with the more than one slot.

20. An apparatus for wireless communication, comprising:
means for receiving an indication of a start and length indicator value (SLIV) that indicates a time domain resource allocation of more than one slot; and
means for communicating a plurality of demodulation reference signals (DMRSs) in accordance with one or more DMRS patterns associated with one or more time segments including one or more boundaries in the more than one slot.
